(19) United States
(12) Patent Application Publication
(10) Pub. No.: US 2019/0361584 A1
(43) Pub. Date: Nov. 28, 2019

(54) INFERRING EXIT ON SCROLLING AND THRESHOLD

(71) Applicant: VE GLOBAL UK LIMITED, London (GB)

(72) Inventor: Rafa MACIAS, London (GB)

(21) Appl. No.: 16/472,372

(22) PCT Filed: Dec. 22, 2017
(86) PCT No.: PCT/EP2017/084382

§ 371 Date: Jun. 21, 2019

(30) Foreign Application Priority Data
Dec. 22, 2016 (GB) 1622027.9

(51) Int. Cl. G06F 3/0485; G06N 5/04

(52) U.S. Cl. CPC G06F 3/0485; G06F 16/954; G06N 5/04

(57) ABSTRACT

The invention provides a method of inferring exit behaviour of a user of a user device, the method comprising: displaying a page in a display portion of the user device; detecting scrolling of the displayed page; detecting a threshold condition; inferring an intent to exit the page in dependence on detecting scrolling in combination with the threshold condition being met, the method further comprising: detecting the orientation of the display of the page within the display portion; setting a threshold of the threshold condition in dependence on the orientation; detecting if the orientation changes; and changing the threshold if the orientation changes.

### BACKGROUND TO THE INVENTION

### Filed of the Invention

The present invention is concerned with inferring exit-intent when accessing a page such as a web page, and in particular in inferring exit-intent on a displayed page utilising scrolling.

### Description of the Related Art

It is known in the art to infer an exit-intent of a user accessing a web page.

FIG. 1 illustrates an example display in a conventional computing device such as a desktop computer or a laptop computer operating with a mouse.

A display area 2 includes a graphical display portion 4 for displaying a web page, a menu area 10 in which a web site address may be entered, a menu icon 6 representing an exit function, and a menu icon 8 representing a back function. Also illustrated in

FIG. 1 is an arrow 12 representing a cursor position on the display.

As a mouse (not shown) is moved, the arrow 12 moves. A user controls the mouse, and may control the mouse, for example, to move the arrow over the menu icon 6 representing an exit function. Software may be provided to implement functionality to detect exit-intent in such a scenario, by detecting movement of the cursor controlled by the mouse toward the menu icon 6.

Example prior art techniques for inferring exit-intent based on mouse-controlled curser behaviour can be found in U.S. Pat. No. 8, 806,327 and U.S. Pat. No. 8,645,212.

It is an aim to provide an improved technique for inferring exit-intent.

### SUMMARY OF THE INVENTION

According to one aspect the invention provides a method of inferring exit behaviour of a user of a user device, the method comprising: displaying a page in a display portion of the user device; detecting scrolling of the displayed page; detecting a threshold condition; inferring an intent to exit the page in dependence on detecting scrolling in combination with the threshold condition being met, the method further comprising: detecting the orientation of the display of the page within the display portion; setting a threshold of the threshold condition in dependence on the orientation; detecting if the orientation changes; and changing the threshold if the orientation changes.

The step of detecting scrolling of the displayed page may comprise detecting scrolling of the displayed page in a first direction and detecting scrolling of the displayed page in a second direction. The step of inferring an intent to exit may be in dependence on detecting scrolling in the first direction followed by scrolling in the second direction.

The orientation may indicate the orientation of the page with respect to the display portion, wherein the display portion is longer in one direction than the other, and in a first orientation the page is scrolled with respect to the shorter dimension, and in a second orientation the page is scrolled with respect to the longer dimension. In the first orientation the page may be displayed in a landscape style and in the second orientation the page may be displayed in a portrait style.

The threshold may be a predetermined position on the page which is not visible before the first scrolling, wherein the position is adjusted between orientations so as to be not visible in either orientation before first scrolling.

The threshold may be a predetermined position on the page which is visible before the first scrolling, wherein the position is adjusted between orientations so as to be visible in both orientations before first scrolling.

The threshold may comprise a scrolling speed threshold in any one of: a first direction; and a second direction.

The threshold may be a percentage of the page having been displayed in the display portion following a scrolling operation.

The first and second directions may be parallel to an edge of the display portion.

The first direction may be vertically downwards and the second direction may be vertically upwards with respect to the edge of the display portion and an orientation of the displayed content.

The page may be a web page or a page of an application.

There is disclosed a computer program product for storing computer program code which, when executed on a computer, performs any described method.

In another aspect the invention provides a device comprising a display portion in which a page is displayed to a user, the page being larger than the display portion such that the page is scrolled in the display portion for display of the page to the user, the device further comprising: a scrolling detector for detecting scrolling of the displayed page within the display portion; a threshold detector for detecting a threshold condition; a processor configured to infer an exit intent of the user from the displayed page in dependence on the detecting scrolling in combination with a threshold condition being met; and an orientation detector for detecting the orientation of the display of the page within the display portion; wherein the processor is further configured to: set a threshold of the threshold condition in dependence on the orientation; and adjust the threshold if the orientation changes.

The scrolling detector may comprise: a first detector for detecting scrolling of the displayed page within the display portion in a first direction; and a second detector for detecting scrolling of the displayed page within the display portion in a second direction different to the first direction, wherein the processor is configured to infer an exit intent in dependence on the first detector detecting scrolling in the first direction followed by the second detector detecting scrolling in the second direction.

The device may further comprise a first speed scrolling detector for detecting a speed of scrolling in a first direction, the processor being configured to set a first speed scrolling threshold.

The device may further comprise a second speed scrolling detector for detecting a speed of scrolling in a second direction, the processor being configured to set a second speed scrolling threshold.

The device may further comprise a page location detector, configured to detect a position of a page appearing in the display region, the processor being configured to set a position threshold.

The device may further comprise a page location detector, configured to detect a position of a page no longer appearing in the display region, the processor being configured to set a position threshold.

The device may further comprise a displayed page detector for detecting the percentage of the page displayed in the displayed region following scrolling in one direction, the processor being configured to set a percentage threshold.

### BRIEF DESCRIPTION OF THE FIGURES

The invention is now described by way of reference to the accompanying figures, in which:

FIG. 1 illustrates a display of a device utilising a conventional mouse-controlled-cursor;

FIG. 2 illustrates a display of a device utilising a scrolling display;

FIG. 3 illustrates a scrolled web page relative to a display;

FIGS. 4(a) to 4(c) illustrate a first example in which an exit-intent in a scrolled display may be inferred by detecting scrolling up and scrolling down;

FIG. 5 illustrates a process in accordance with the first example;

FIGS. 6(a) to 6(c) illustrate a second example in which an exit-intent in a scrolled display may be inferred by detecting a speed of scrolling;

FIG. 7 illustrates a process in accordance with the second example;

FIGS. 8(a) to 8(d) illustrate a third example in which an exit-intent in a scrolled display may be inferred by detecting a scroll to a predetermined position;

FIG. 9 illustrates a process in accordance with the third example;

FIGS. 10(a) to 10(d) illustrate a fourth example in which an exit-intent in a scrolled display may be inferred by detecting a scroll from a predetermined position;

FIG. 11 illustrates a process in accordance with the fourth example;

FIGS. 12(a) to 12(d) illustrate a fifth example in which an exit-intent in a scrolled display may be inferred by detecting a scroll of a predetermined percentage;

FIG. 13 illustrates a process in accordance with the fifth example;

FIGS. 14(a) and 14(b) illustrate a sixth example in which an exit-intent in a scrolled display may be inferred dependent on detection of a threshold, which threshold is variable in dependence on the orientation of the display;

FIG. 15 illustrates a process in accordance with the sixth example;

FIG. 16 illustrates a device architecture with which described examples may be utilised; and

FIG. 17 illustrates an example implementation of a 3^{rd} party software application in conjunction with a website.

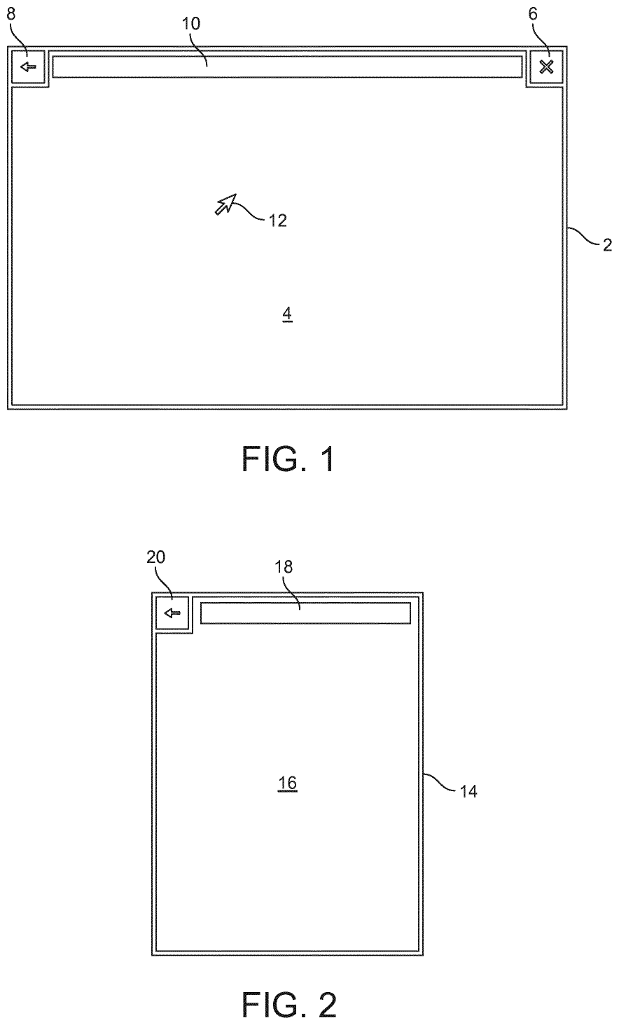

### DESCRIPTION OF PREFERRED EMBODIMENTS

The invention is now described with reference to preferred examples and embodiments. In particular the invention is described in the context of examples where a web page interface is provided by a touch contact, and scrolling of the web page under the control of a touch contact is used. In such scenarios, a mouse is not provided, and a cursor under the control of a mouse is not displayed.

FIG. 2 illustrates an example display of an exemplary computing device which does not operate with a mouse. In the described example such a device is considered to be a mobile telephone, but the device is not limited to a mobile telephone. The device may be any device which permits navigation of a display by scrolling of page content, for example by using a user's finger to scroll content.

Referring to FIG. 2 such a device includes a display area 14 having a graphical display portion 16. In this example there is also shown a menu area 18 in which a web site address may be entered, and a menu icon 20 representing a back function.

The operation of a web page browsing operation in a typical device such as shown in FIG. 2 is now described, such a web page browsing operation utilising scrolling.

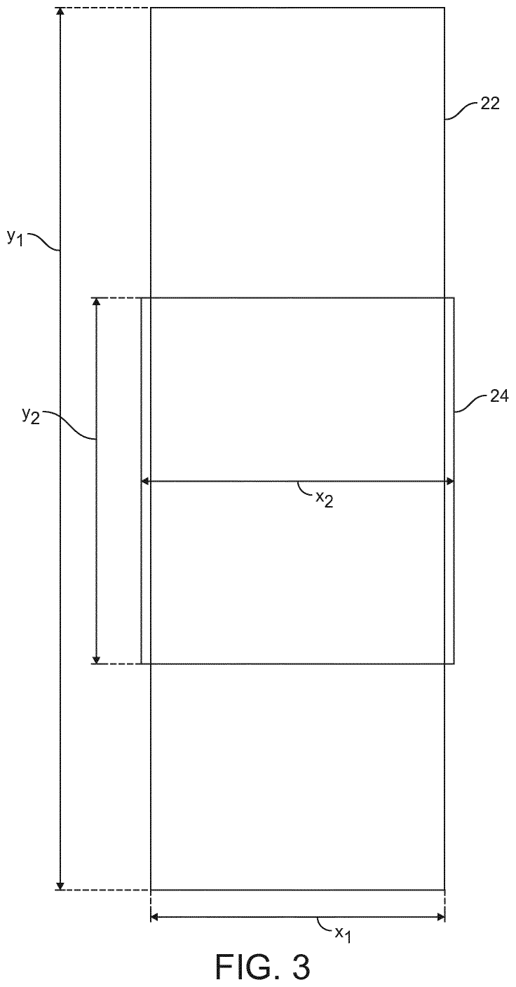

FIG. 3 illustrates a general principle of operation in web browsing using scrolling. Reference numeral 22 identifies a web page, and reference numeral 24 identifies a display portion of a device.

As can be seen in FIG. 3, the web page 22 has a width x₁ which fits within the width x₂ of the display portion 24 of the device, i.e. x₁<x₂. The web page 22 has a length y₁, however, that exceeds the length y₂ of the display portion of the device, i.e. y₁>y₂. Thus only a portion of the web page can be shown within the display portion at any instant, and at any instant there are portions of the web page above and/or below the display portion 24 which are not visible. The web page 22 may be scrolled up and down by a user swiping their finger up and down on the display portion 24, to move the displayed portion up and down to show different portions in the visible display portion.

In such a scenario it is not possible to use exit-intent techniques which are known in mouse-controlled cursor technologies, as there is no mouse cursor.

Furthermore, an application utilising scrolling typically displays just the page contents as it is scrolled down. The navigation bar, where a user can enter a URL and exit the page, is no longer visible once the user scrolls down. To access the navigation bar the user scrolls back up after scrolling down. If a user wishes to exit a web page after scrolling down, they need to scroll back up first.

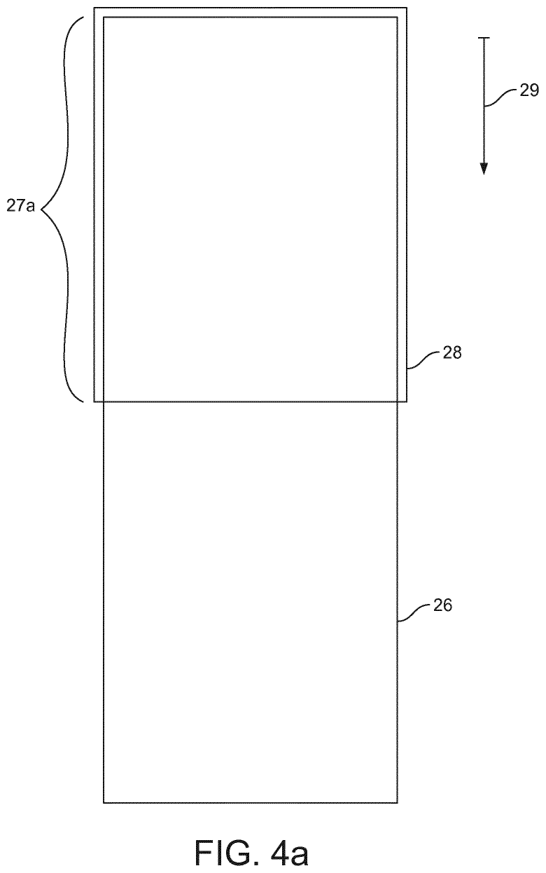

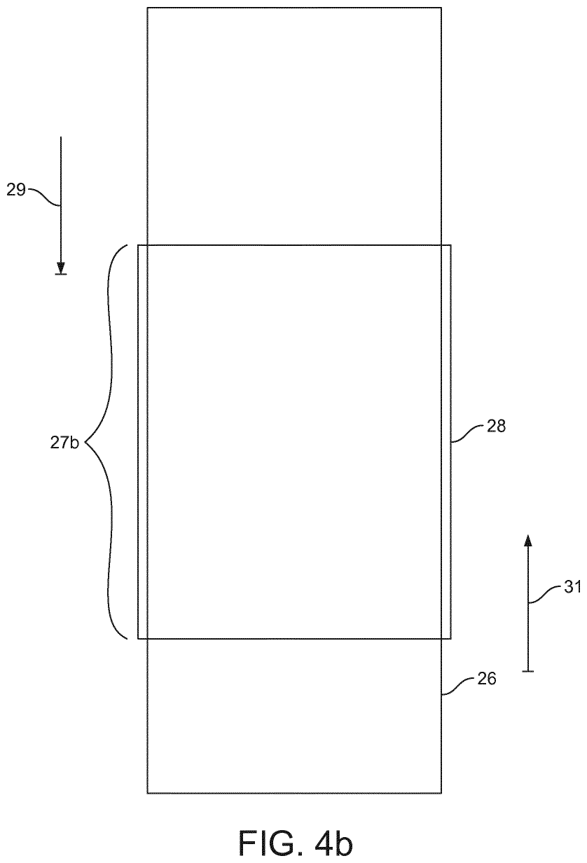

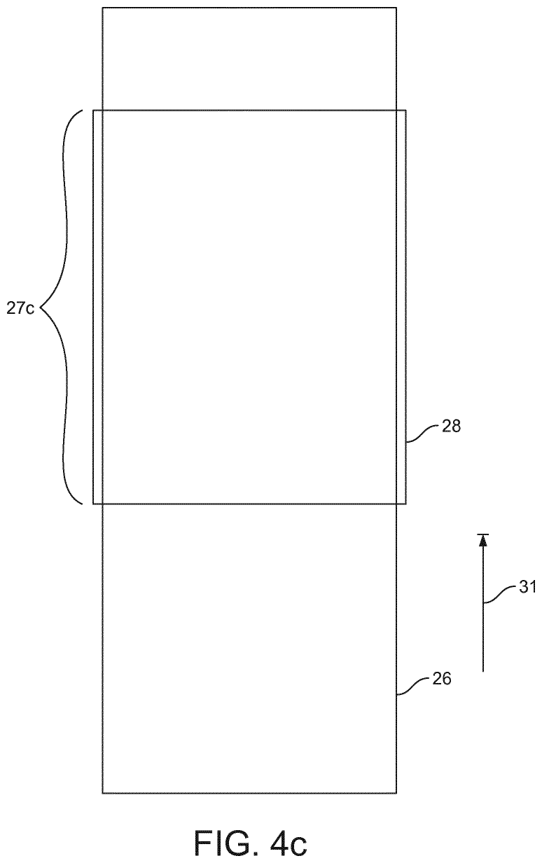

A first example technique is described with reference to FIGS. 4(a) to 4(c). In this first example technique, website exit intent may be inferred by detecting scroll up and scroll down of the web page.

With reference to FIG. 4(a), there is illustrated a web page 26 and a display portion 28 of a mobile device. As shown in FIG. 4(a) when the web page 26 is initially opened only a top portion, as denoted by reference numeral 27a, of the web page is visible in the display portion 28. The user must scroll down the web page 26 to show further portions of the web page 26 in the display region 28.

It will be understood that the display portion 28 of FIG. 4(a), and as referred to in all the following examples, may be part of a mobile device which is held for example in a user's hand, and the user scrolls the web page by swiping their finger on a screen of the display portion 28.

In all the following examples reference is made to ‘scroll down’ and ‘scroll up’. In general references to scrolling up and down can be understood as references to scrolling in a first and second direction, the first and second directions being different to each other, and preferably being opposite to other. In the examples a scroll down operation is understood to move a portion of the web page below the display portion 28 into the display portion 28, and a scroll up operation is understood to move a portion of the web page above a display portion 28 into the display portion 28.

Referring again to FIG. 4(a), on opening the web page the scenario as shown in FIG. 4(a) is presented, with an upper most portion of a web page 26 (denoted by reference numeral 27a ) displayed in the display region 28. As denoted by arrow 29, the user then scrolls downwardly.

As shown in FIG. 4(b), after this scrolling a different portion of the web page 26 is visible in the display region 28, as denoted by reference numeral 27b.

Following the scenario as shown in FIG. 4(b), the user then scrolls upwardly as denoted by arrow 31. As shown in FIG. 4(c), after this scrolling a different portion 27c of the web page 26 is visible in the display region 28.

The sequence in FIGS. 4(a) to 4(c) thus shows a sequence of scrolling the web page downwardly followed by scrolling the web page upwardly. In accordance with this first example, detection of such conditions may be used to infer exit intent from the web page.

Following determination of an exit-intent, the operation may be consistent with the determination of an exit-intent in prior art scenarios using detection of a cursor movement.

For example, in dependence on detection of exit-intent, a further software application may be triggered and a pop-up displayed to the user. This pop-up will be implementation dependent, and may be provided by 3^{rd} party software. The pop-up may be a window which questions the user as to whether they are sure they want to exit the web page. The provision of such a pop-up window, by 3rd party software or otherwise, will be known to one skilled in the art.

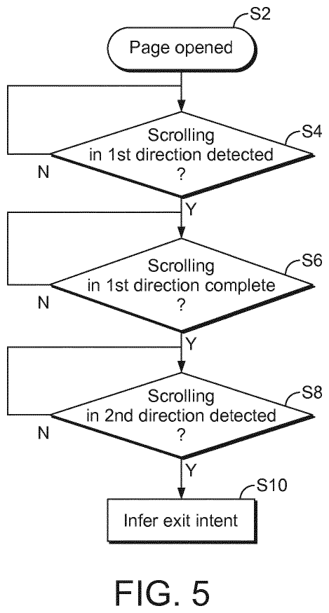

FIG. 5 shows an exemplary process in accordance with this first example.

In a step S2 a web page is opened, and as in accordance with FIG. 4(a) a portion of this web page is displayed in the display region.

In a step S4 a determination is made as to whether scrolling in a first direction, e.g. downward scrolling, is detected. If such scrolling is not detected, then the detection step S4 continues.

If scrolling in the first direction is detected, then in a step S6 it is determined whether that scrolling operation is completed. If such scrolling is not complete, then the detection step S6 continues. If scrolling in the first direction is determined to be complete, then in a step S8 a determination is made as to whether scrolling in a second direction is detected. If such scrolling is not detected, then the detection step S8 continues.

If scrolling in the second direction is detected, then in a step S10 exit intent is inferred.

In an example, the step S8 may be enabled after a completed scrolling in the first direction is detected, even if there are subsequent scrollings also in the first direction.

In an example, the step S8 may be enabled as soon as a completed scrolling in the first direction is detected. In other examples, a further threshold condition may have to be met prior to step S8 being enabled, such threshold being any one of the conditions described below in relation to other examples.

In examples, the exit intent in step S10 may be inferred as soon as the scrolling in the second direction is detected once step S8 is enabled. In other examples, a further threshold condition may have to be met prior to step S10 being enabled to infer exit intent, such threshold being any one of the conditions described below in relation to other examples.

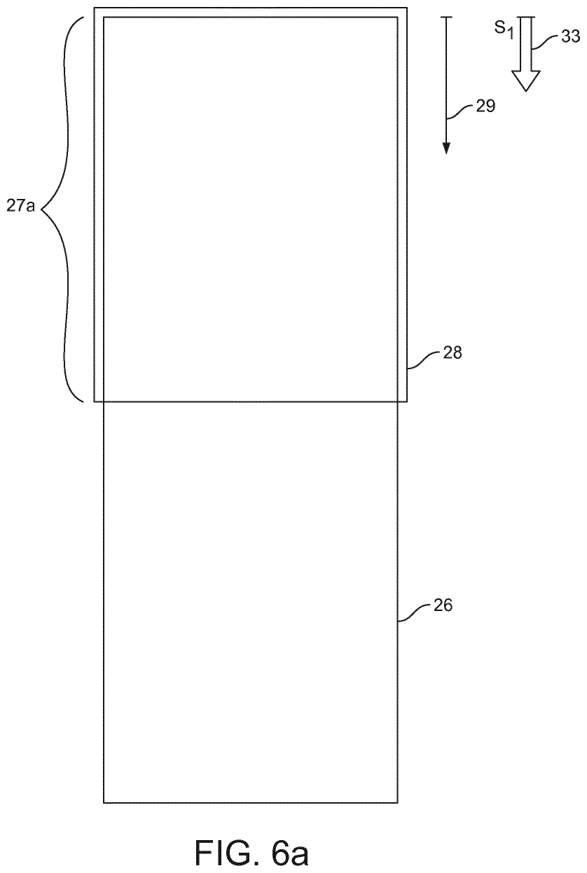

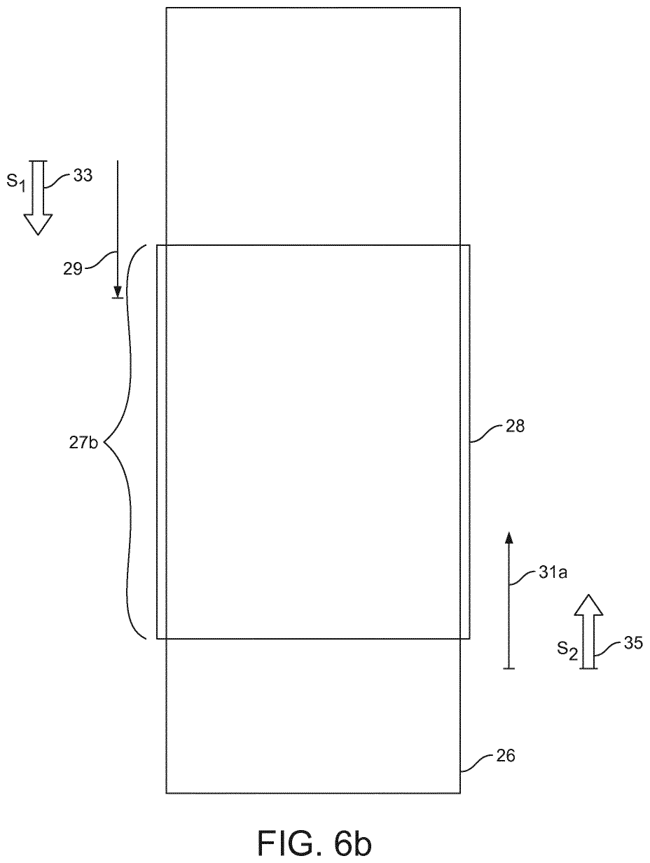

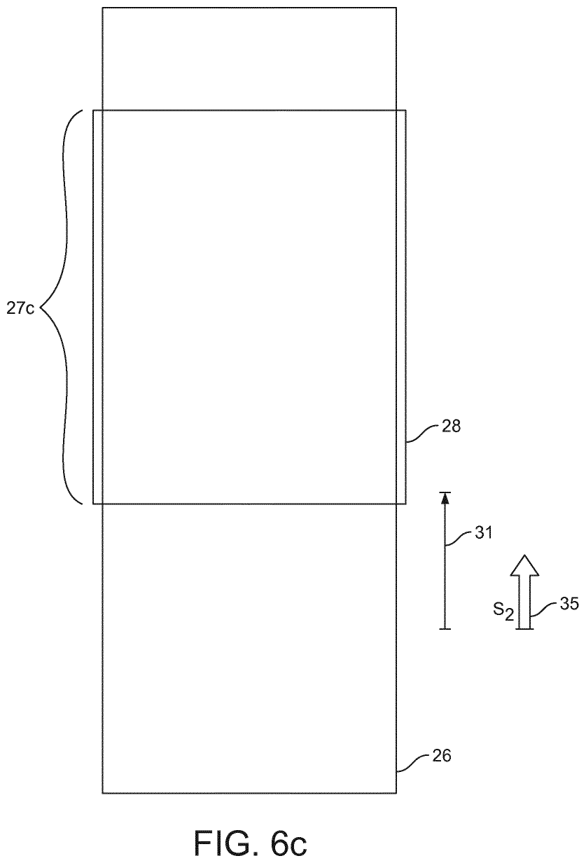

A second example technique is described with reference to FIGS. 6(a) to 6(c). In this second example technique, website exit intent may be inferred by detecting scroll up and scroll down of the web page in combination with a speed of scrolling in one or both directions.

With reference to FIG. 6(a), there is illustrated the web page 26 and the display portion 28 of the exemplary mobile device. As again shown in FIG. 6(a) when the web page 26 is initially opened only a top portion, as denoted by reference numeral 27a, of the web page is visible in the display portion 28. The user must scroll down the web page 26 to show further portions of the web page 26 in the display region 28. On opening the web page the scenario as shown in FIG. 6(a) is presented, with an upper most portion of a web page 26 (denoted by reference numeral 27a ) displayed in the display region 28.

As denoted by arrow 29 of FIG. 6(a), the user then scrolls downwardly. As denoted by arrow 33, the scroll down is performed with a speed s₁. As shown in FIG. 6(b), after this scrolling a different portion of the web page 26 is visible in the display region 28, as denoted by reference numeral 27b.

It is assumed that the speed associated with the scrolling denoted by arrow 29 has a speed s₁. This may be determined for example as the average speed for the duration of the scrolling, or the maximum speed detected during the duration of the scrolling.

Following the scenario as shown in FIG. 6(b), the user then scrolls upwardly as denoted by arrow 31. As denoted by arrow 35, the scroll up is performed with a speed s₂. As shown in FIG. 6(c), after this scrolling a different portion of the web page 26 is visible in the display region 28, as denoted by reference numeral 27c.

It is assumed that the speed associated with the scrolling denoted by arrow 31 has a speed s₂. This may be determined for example as the average speed for the duration of the scrolling, or the maximum speed detected during the duration of the scrolling.

The scrolling speed of either the downward scrolling, the speed of the upward scrolling, or both may be detected.

The sequence in FIGS. 6(a) to 6(c) thus shows a sequence of scrolling the web page downwardly followed by scrolling the web page upwardly. In addition, the scrolling speed in either the downward or upward direction, or both, is additionally detected. In accordance with this second example, detection of such conditions may be used to infer exit intent from the web page.

The action following inference of an exit intent is as described elsewhere.

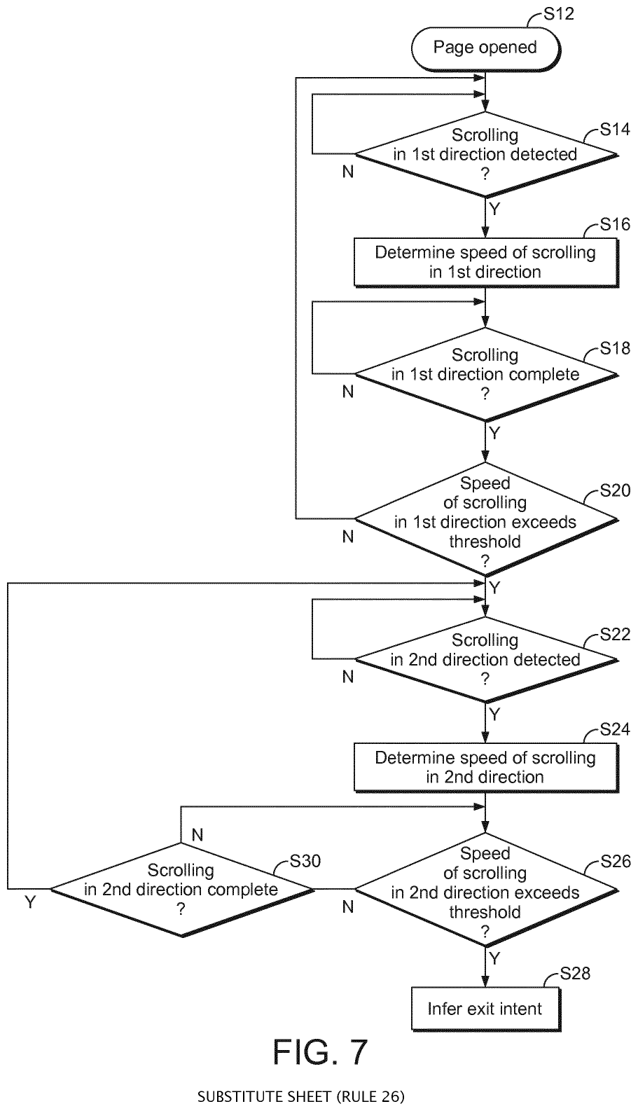

FIG. 7 shows an exemplary process in accordance with this second example.

In a step S12 a web page is opened, and as in accordance with FIG. 6(a) a portion of this web page is displayed in the display region. In a step S14 a determination is made as to whether scrolling in a first direction, e.g. downward scrolling, is detected. If such scrolling is not detected, then the detection step S14 continues.

If scrolling in the first direction is detected, then in a step S16 the speed of that scrolling is optionally determined. This speed may be determined based on detection of a maximum speed, a maximum speed over a specific time duration of the scrolling, or the average speed for the entire scrolling operation period or a portion of that period after the scrolling is determined as complete.

In a step S18 it is determined whether the scrolling operation detected in step S16 is complete. If such scrolling is not complete, then the detection step S18 continues and the speed continues to be monitored/determined in step 516.

If scrolling in the first direction is determined to be complete, then in a step S20 an optional determination is made as to whether the speed of scrolling determined for the scrolling in the first direction exceeds a predetermined threshold. The threshold may be set by the web page, by the user device, or by any other means.

If the threshold is not met, then the process returns to step S14 and detection of scrolling in the 1^{st} direction continues to be monitored.

If the threshold is met, then a step S22 is enabled to detect subsequent scrolling in the second direction. The step S22 may also be enabled if the optional steps S16 and S20 are omitted.

In step S22 a determination is made as to whether scrolling in a second direction is detected. If such scrolling is not detected, then the detection step S22 continues.

If scrolling in the second direction is detected, then in a step S24 the speed of that scrolling is optionally determined. This speed may be determined based on detection of a maximum speed, a maximum speed over a specific time duration of the scrolling, or the average speed for the entire scrolling operation period or a portion of that period after the scrolling is determined as complete.

In a step S26 it is optionally determined whether the speed of scrolling determined for the scrolling in the second direction exceeds a predetermined threshold. The threshold may be set by the web page, by the user device, or by any other means. The threshold applied in step S26 may be different to the threshold applied in step S20.

If the threshold is not met, then the process moves to step S30. In step S30 it is determined whether the scrolling in the second direction has completed. If it has, then the process returns to step S22 and detection of scrolling in the second direction continues to be monitored for. If the current scrolling in the second direction has not stopped, then the process returns to step S26 and the speed of scrolling continues to be compared to a threshold.

If the threshold is met, then in a step S28 exit intent is inferred.

In an example, the step S28 may be enabled as soon as a completed scrolling in the first direction is detected. In another example, a speed threshold condition has to be met as described. In further examples, a further threshold condition may have to be met prior to step S22 being enabled, such threshold being any one of the conditions described below in relation to other examples.

In an example, the exit intent in step S28 may be inferred as soon as the scrolling in the second direction is detected. In another example the exit intent in step S28 may be inferred only when the scrolling is detected as exceeding a threshold as described. In further examples, a further threshold condition may have to be met prior to step S28 being enabled to infer exit intent, such threshold condition being any one of the conditions described below in relation to other examples.

In a preferred example the exit intent is set following detection of scrolling in the first direction, followed by scrolling in the second direction, the scrolling in the second direction exceeding a speed threshold.

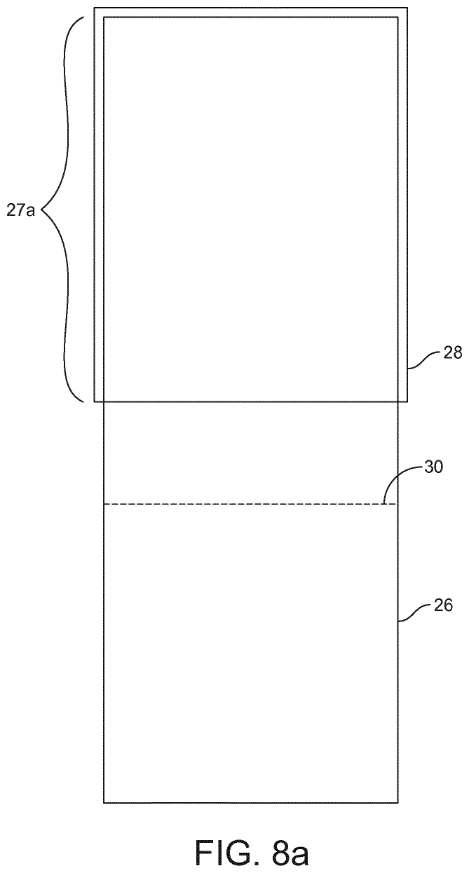

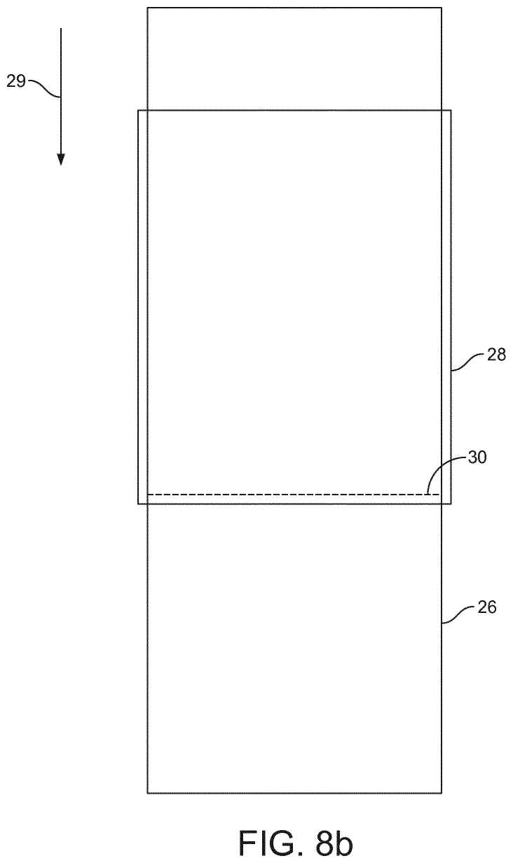

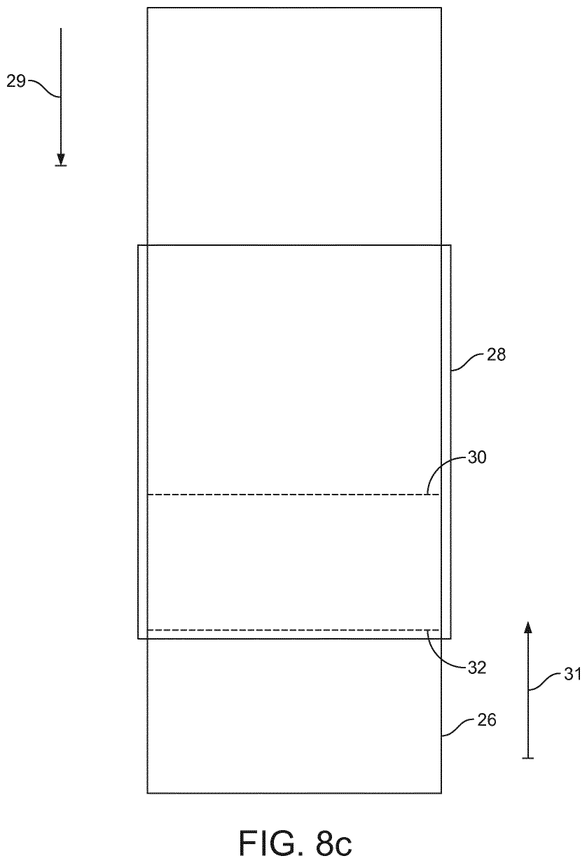

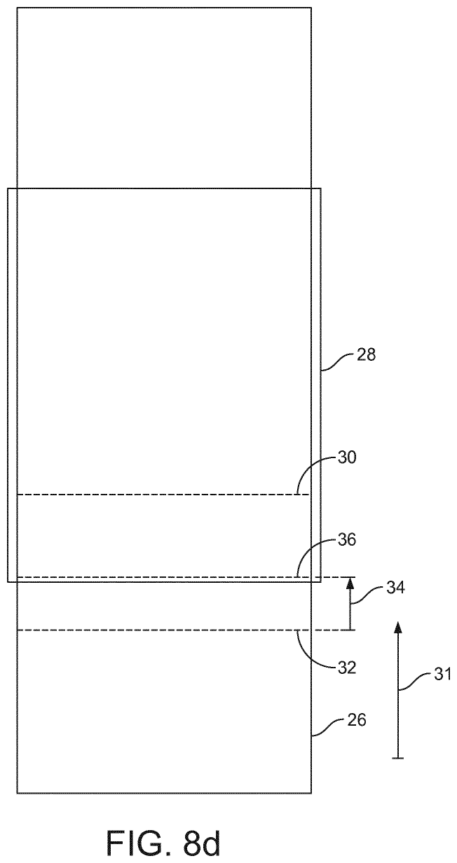

A third example technique is described with reference to FIGS. 8(a) to 8(d). In this third example technique, website exit intent may be inferred by detecting scroll up and scroll down of the web page in combination with scrolling to reveal a predetermined position.

With reference to FIG. 8(a), there is again illustrated the web page 26 and the display portion 28 of the exemplary mobile device. Again is shown in FIG. 8(a) that when the web page 26 is initially opened only a top portion, as denoted by reference numeral 27a, of the web page is visible in the display portion 28. The user must scroll down the web page 26 to show further portions of the web page 26 in the display region 28. On opening the web page the scenario as shown in FIG. 6(a) is presented, with an upper most portion of a web page 26 (denoted by reference numeral 27a ) displayed in the display region 28.

A line of the web page 26 denoted by reference numeral 30 is marked as a predetermined location in the web page 26 in FIG. 8(a). This line may be defined by a vertical pixel location. In this third described example this line is set at a location which is not visible when the web page is initially opened.

The location of the line 30 may be predetermined for the website associated with the webpage, for the particular web page, or for the user. The line 30 is an example of a threshold.

As shown in FIG. 8(b), the user scrolls down the web page as denoted by arrow 29 for a certain distance, and the location of line 30 becomes visible in the display region 28. The positioning of the line 30 in the display portion may be considered a first detection trigger. When the line 30 become visible, the first detection trigger is set. The appearance of the line 30 may also be considered the condition of a first threshold having been met.

As shown in FIG. 8(c), the user continues to scroll down as denoted by arrow 29, and the line 30 becomes higher within the display region 28. As denoted by reference numeral 32, there is a line of the web page 26 which is the furthest point of the web page which has been displayed. It is assumed that the line 32 represents the position at which scrolling in the direction of arrow 29 stops.

At this instant in time, the user scrolls up the web page as denoted by arrow 31. That is, the user scrolls in the opposite direction to the direction which caused the first trigger to be set. As the user scrolls up, the distance between the furthest point reached in the web page (denoted by line 32), and the current lowest point of the web page being displayed, which is represented by line 36 in FIG. 8(d), is determined. This dimension is denoted by arrow 34 in FIG. 8(d).

A threshold distance is optionally set in a preliminary step before the web page is accessed. This threshold distance may be set in conjunction with the setting of the line 30. The setting of the threshold distance will also be implementation dependant, and may vary for a website, a web page or a user.

As and when the distance denoted by arrow 34 exceeds the threshold, a second detection trigger is set.

Responsive to the first detection trigger followed by the second detection trigger, an exit-intent is inferred. The action following inference of an exit intent is as described elsewhere.

In accordance with this third example, it may be determined that the web page has been scrolled in a downward and an upward direction, and in addition the scrolling in the downward direction reached a predetermined point. Optionally, an additional requirement may be that the scrolling in the upward direction must exceed a certain distance. Therefore there may be two trigger points associated with two thresholds.

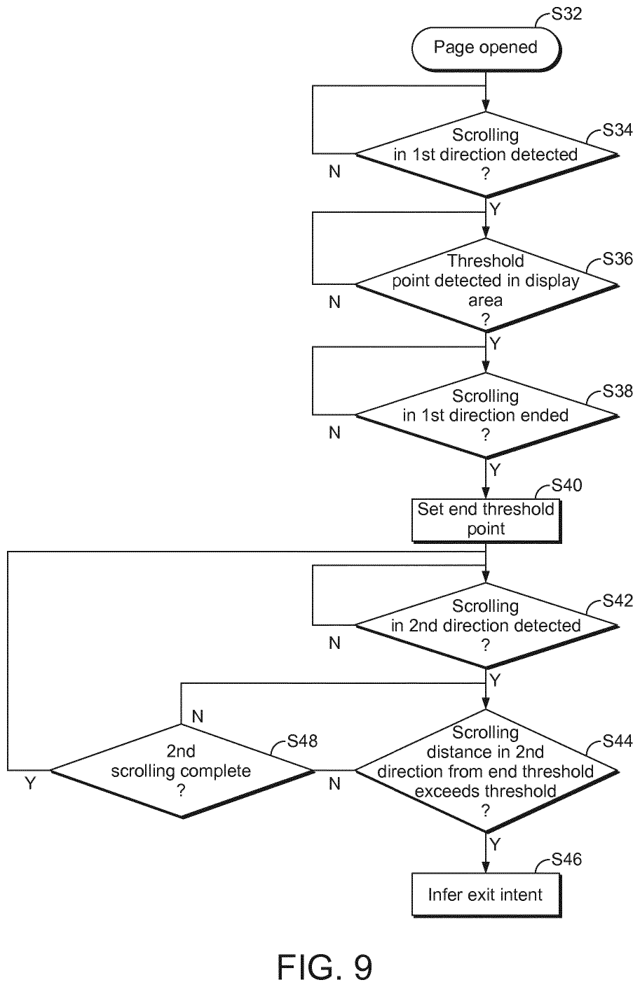

FIG. 9 shows an example process in accordance with this third example.

In a step S32 a web page is opened, and as in accordance with FIG. 8(a) a portion of this web page is displayed in the display region.

In a step S34 a determination is made as to whether scrolling in a first direction, e.g. downward scrolling, is detected. If such scrolling is not detected, then the detection step S34 continues.

If scrolling in the first direction is detected, then in a step S36 a determination is made as to whether a predetermined location on the web page, which was not displayed in the display region initially, is detected as being displayed in the display region. Such a predetermined location of the web page may be considered a threshold, and thus a determination is made as whether the threshold—or threshold point being a location or event position in the web 0page—is detected in the display area. This corresponds to line 30 in FIGS. 8(a) to 8(d).

If this threshold point is not detected as being within the display region, then the process remains in step S36. If the threshold point is detected, then in a step S38 it is determined whether the scrolling in the first direction has stopped. If it has not, then the process remains in step S38.

If it is determined in step S38 that scrolling in the first direction has ended, then the process in step S40 sets an end threshold point. This end threshold point corresponds to line 32 in FIG. 8(c), and denotes the location at which the first scrolling has completed, and the extent to which the web page has been scrolled.

In a step S42 the process then monitors for detection of scrolling in a second direction. If no such scrolling is detected, then the process remains in step S42. If scrolling in the second direction is detected, then in step S44 a determination is made as to whether the distance scrolled in the second direction from the end threshold exceeds another threshold. With reference to FIG. 8(d), this corresponds to determining whether the current location which represents the position to which the display has been scrolled to (line 36) has resulted in a distance of movement since the end threshold point (line 32) which exceeds another threshold. This is represented in FIG. 8(d) by arrow 34. The distance 34 varies as the second scrolling continues.

If the threshold condition is not met in step S44, a determination is made as to whether the scrolling in the second direction is complete. If it is not, then the process remains in step S44. If it has, then the process returns to step S42.

If in step S44 it is determined that the threshold is exceeded, then exit intent is inferred.

In further examples, a further threshold condition may have to be met prior to step S42 being enabled, such threshold being any one of the conditions described above or below in relation to other examples.

In an example, the exit intent in step S46 may be inferred as soon as the scrolling in the second direction is detected. In another example the exit intent in step S46 may be inferred only when the distance scrolled in the second direction is detected as exceeding a threshold as described. In further examples, a different or additional threshold condition may have to be met prior to step S46 being enabled to infer exit intent, such threshold condition being any one of the conditions described above or below in relation to other examples.

In a preferred example the exit intent is set following detection of scrolling in the first direction to the predetermined (threshold) position not initially displayed in the display region becoming displayed in the display region, followed by scrolling in the second direction by a predetermined (threshold) amount.

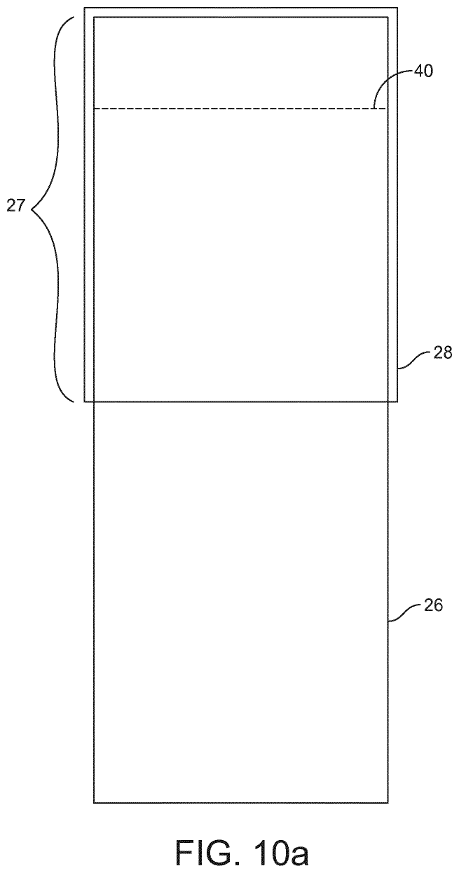

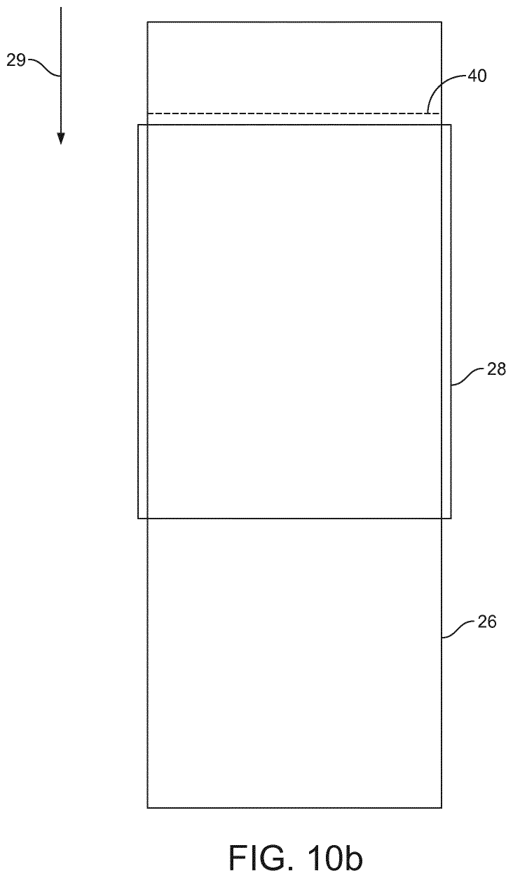

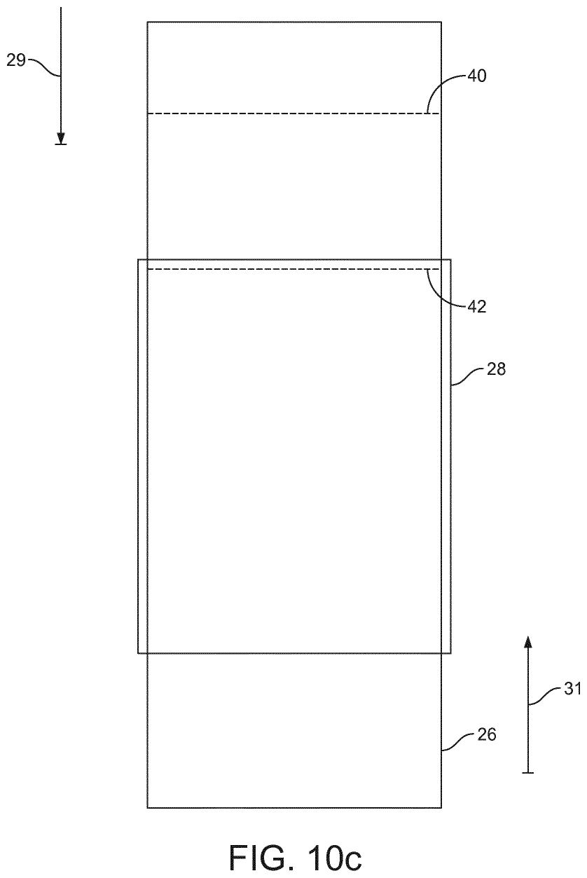

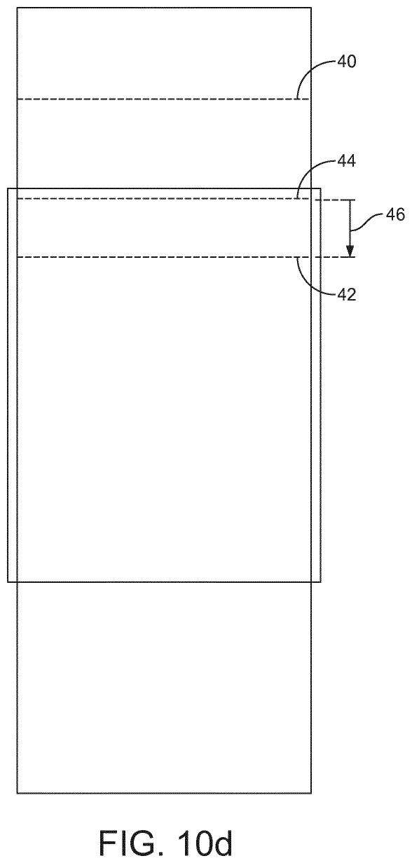

A fourth example technique is described with reference to FIGS. 10(a) to 10(d). In this fourth example technique, website exit intent may be inferred by detecting scroll up and scroll down of the web page in combination with scrolling to conceal a predetermined position.

With reference to FIG. 10(a), there is again illustrated the web page 26 and the display portion 28 of the exemplary mobile device. Again is shown in FIG. 10(a) that when the web page 26 is initially opened only a top portion, as denoted by reference numeral 27a, of the web page is visible in the display portion 28. The user must scroll down the web page 26 to show further portions of the web page 26 in the display region 28. On opening the web page the scenario as shown in FIG. 10(a) is presented, with an upper most portion of a web page 26 (denoted by reference numeral 27a ) displayed in the display region 28.

A line of the web page 26 denoted by reference numeral 40 is marked as a predetermined location in the web page 26 in FIG. 10(a). This line may be defined by a vertical pixel location. In this fourth described example this line is set at a location which is visible when the web page is initially opened.

The location of the line 40 may be predetermined for the website associated with the webpage, for the particular web page, or for the user. The line 40 is an example of a threshold.

As shown in FIG. 10(b), the user scrolls down the web page 26 as denoted by arrow 29 for a certain distance, and the location of line 40 is no longer visible in the display region 28. The movement of the line 40 out of the display portion may be considered a first detection trigger. When the line 40 is no longer visible, the first detection trigger is set.

As shown in FIG. 10(c), the user continues to scroll down as denoted by arrow 29, and the line 40 becomes ‘higher’, and further away from the display region 28. As denoted by reference numeral 42, there is a line of the web page 26 which is the furthest point of the web page which has been displayed. It is assumed that the line 42 represents the position at which scrolling in the direction of arrow 29 stops.

At this instant in time, the user scrolls up the web page as denoted by arrow 31. That is, the user scrolls in the opposite direction to the direction which caused the first trigger to be set. As the user scrolls up, the distance between the furthest point reached in the web page (denoted by line 42), and the current highest point of the web page being displayed, which is represented by line 44 in FIG. 10(d), is determined. This dimension is denoted by arrow 46 in FIG. 10(d).

A threshold distance is optionally set in a preliminary step before the web page is accessed. This threshold distance may be set in conjunction with the setting of the line 40. The setting of the threshold distance will also be implementation dependant, and may vary for a website, a web page or a user.

As and when the distance denoted by arrow 46 exceeds the threshold, a second detection trigger is set.

Responsive to the first detection trigger followed by the second detection trigger, an exit-intent is inferred. The action following inference of an exit intent is as described elsewhere.

In accordance with this fourth example, it may be determined that the web page has been scrolled in a downward and an upward direction, and in addition the scrolling in the downward direction resulted in a predetermined point which was originally in the display region no longer being in the display region. Optionally, an additional requirement may be that the scrolling in the upward direction must exceed a certain distance. Therefore there may be two trigger points associated with two thresholds.

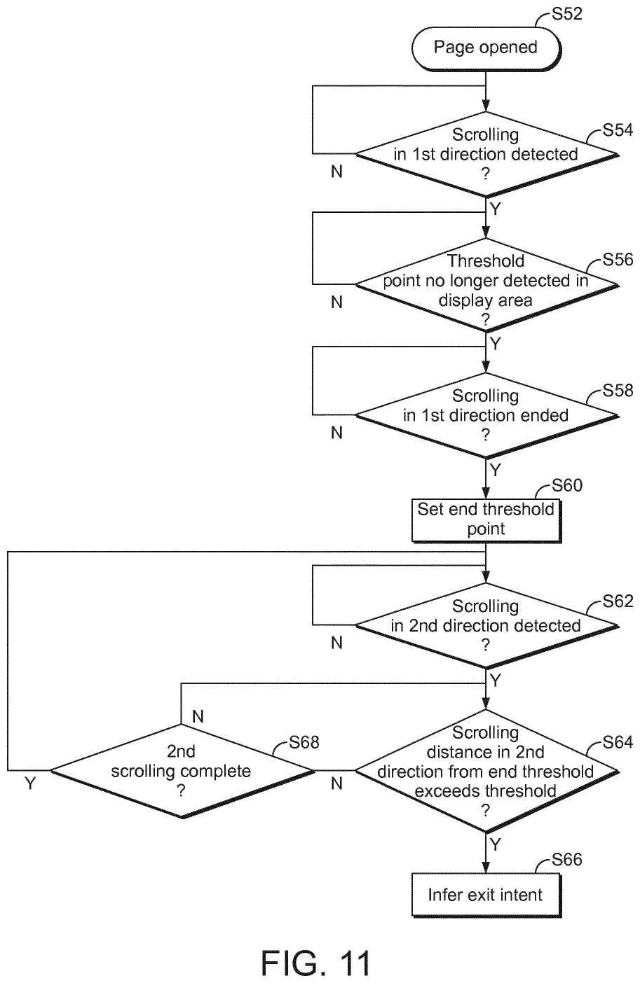

FIG. 11 shows an example process in accordance with this fourth example.

In a step S52 a web page is opened, and as in accordance with FIG. 10(a) a portion of this web page is displayed in the display region.

In a step S54 a determination is made as to whether scrolling in a first direction, e.g. downward scrolling, is detected. If such scrolling is not detected, then the detection step S54 continues.

If scrolling in the first direction is detected, then in a step S56 a determination is made as to whether a predetermined location on the web page, which was displayed in the display region initially, is detected as no longer being displayed in the display region. Such a predetermined location of the web page may be considered a threshold, and thus a determination is made as whether the threshold—or threshold point being a location or event position in the web page—is detected as no longer being in the display area. This corresponds to line 40 in FIGS. 10(a) to 10(d).

If this threshold point is detected as still being within the display region, then the process remains in step S56. If the threshold point is detected as no longer being in the display region, however, then in a step S58 it is determined whether the scrolling in the first direction has stopped. If it has not, then the process remains in step S58.

If it is determined in step S58 that scrolling in the first direction has ended, then the process in step S60 sets an end threshold point. This end threshold point corresponds to line 42 in FIG. 10(c), and denotes the location at which the first scrolling has completed, and the extent to which the web page has been scrolled to.

In a step S62 the process then monitors for detection of scrolling in a second direction. If no such scrolling is detected, then the process remains in step S62. If scrolling in the second direction is detected, then in step S64 a determination is made as to whether the distance scrolled in the second direction from the end threshold exceeds another threshold. With reference to FIG. 10(d), this corresponds to determining whether the current location which represents the position to which the display has been scrolled to (line 44) has resulted in a distance of movement since the end threshold point (line 42) which exceeds another threshold. This is represented in FIG. 10(d) by arrow 46. The distance 46 varies as the second scrolling continues.

If the threshold condition is not met in step S64, a determination is made as to whether the scrolling in the second direction is complete in step S68. If it is not, then the process remains in step S64. If it has, then the process returns to step S62.

If in step S64 it is determined that the threshold is exceeded, then exit intent is inferred and the process moves on to step S66.

In further examples, a further or alternative threshold condition may have to be met prior to step S62 being enabled, such threshold being any one of the conditions described above or below in relation to other examples.

In an example, the exit intent in step S66 may be inferred as soon as the scrolling in the second direction is detected. In another example the exit intent in step S66 may be inferred only when the distance scrolled in the second direction is detected as exceeding a threshold as described. In further examples, a different or additional threshold condition may have to be met prior to step S66 being enabled to infer exit intent, such threshold condition being any one of the conditions described above or below in relation to other examples.

In a preferred example the exit intent is set following detection of scrolling in the first direction from the predetermined (threshold) position which is initially displayed in the display region until it is no longer displayed in the display region, followed by scrolling in the second direction by a predetermined (threshold) amount.

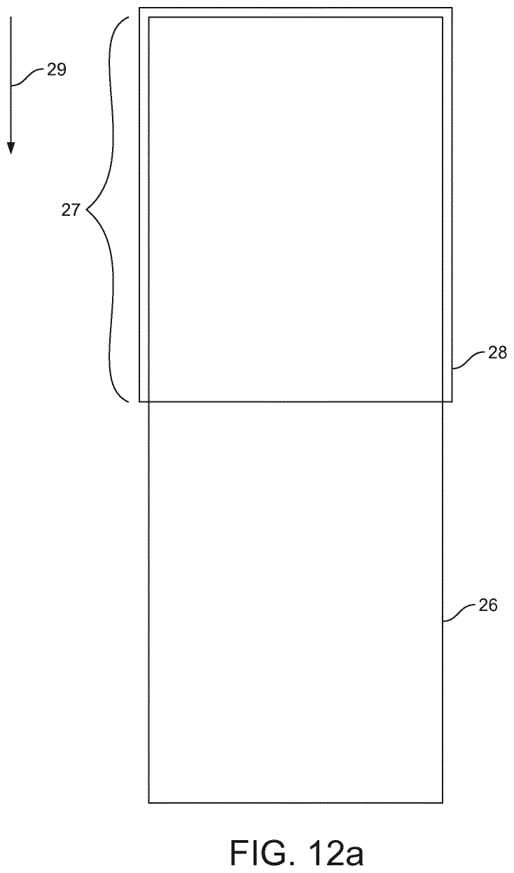

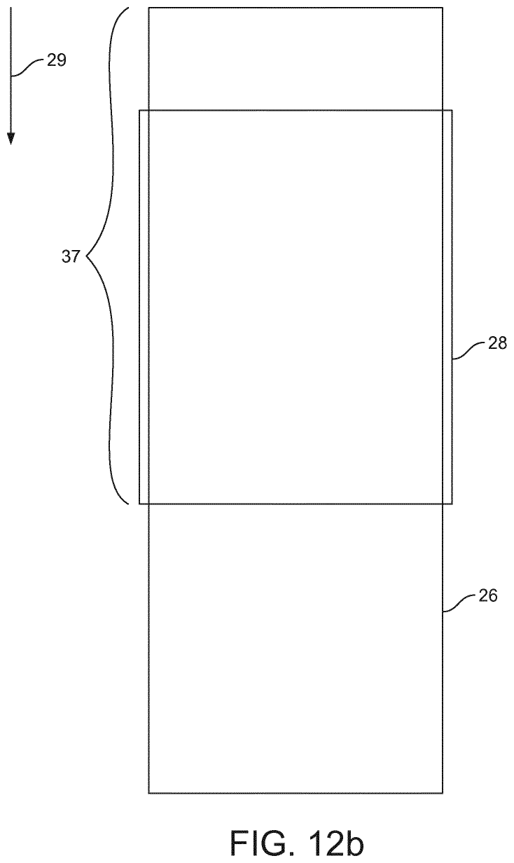

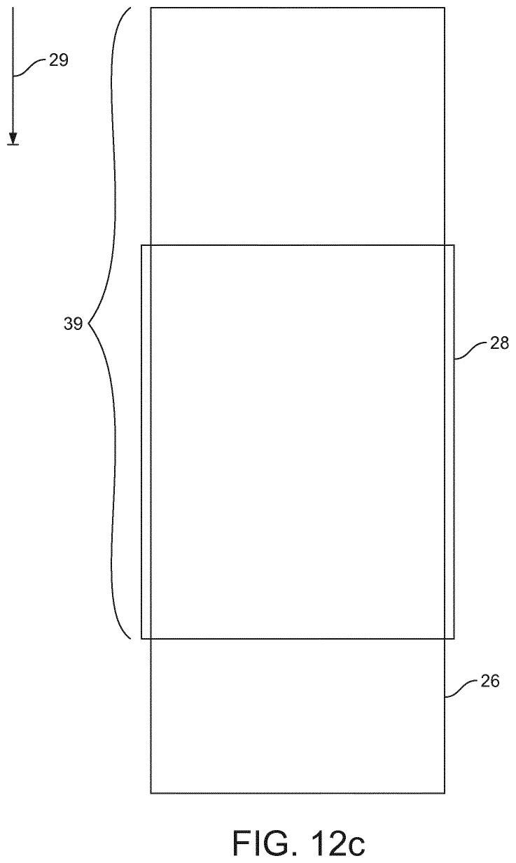

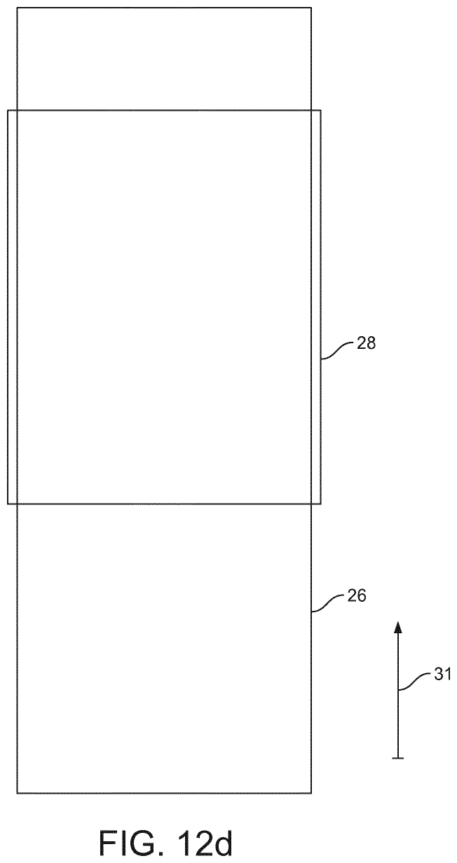

A fifth example technique is described with reference to FIGS. 12 (a) to 12(d). In this fifth example technique, website exit intent may be inferred by detecting scroll up and scroll down of the web page in combination with scrolling by a certain percentage of the total page size.

With reference to FIG. 12(a), there is again illustrated the web page 26 and the display portion 28 of the exemplary mobile device. Again is shown in FIG. 12(a) that when the web page 26 is initially opened only a top portion, as denoted by reference numeral 27a, of the web page is visible in the display portion 28. The user must scroll down the web page 26 to show further portions of the web page 26 in the display region 28. On opening the web page the scenario as shown in FIG. 12(a) is presented, with an upper most portion of a web page 26 (denoted by reference numeral 27a ) displayed in the display region 28.

As denoted in FIG. 12(a), a certain percentage of the total page length is visible when first viewed, as denoted by reference numeral 27.

In accordance with this fifth example, a threshold value is set being a certain percentage of the length of the page, which is preferably larger than the percentage on view in the scenario of FIG. 12(a). In FIG. 12(a), with the portion of the page 27 being the only portion viewed, it can be considered that x% of the page has been viewed.

The page is scrolled down as denoted by arrow 29, and as shown in FIG. 12(b) a portion of the page as denoted by reference numeral 37 has now been viewed: all the page as now visible in the viewing region 28, plus the portion of the page which was previously in this viewing region. It can now be considered that (x+y)% of the page has been viewed.

The page continues to be scrolled down as denoted by arrow 29, and as shown in FIG. 12(c) a portion of the page as denoted by reference numeral 39 has now been viewed: all the page as now visible in the viewing region 28, plus the portion of the page which was previously in this viewing region. It can now be considered that (x+y+z)% of the page has been viewed. FIG. 12(c) represents the final positioning after the scrolling in the direction of arrow 29 has been completed.

A threshold value has been set, of Th%, which is the percentage of the page which must have been displayed for a trigger to be set. Thus it is determined whether (x+y+z)%>Th%. If the threshold is exceeded, then the trigger is set.

Thereafter as denoted by arrow 31 in FIG. 12(d) upward scrolling takes place, and exit intent is inferred. The action following inference of an exit intent is as described elsewhere.

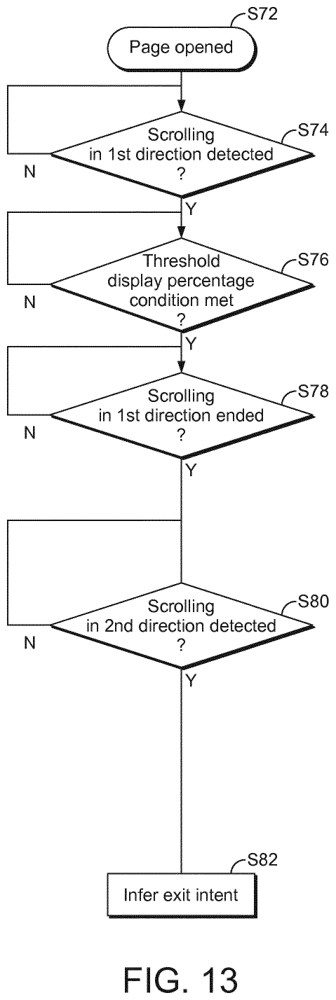

FIG. 13 shows an example process in accordance with this fifth example.

In a step S72 a web page is opened, and as in accordance with FIG. 12(a) a portion of this web page is displayed in the display region.

In a step S74 a determination is made as to whether scrolling in a first direction, e.g. downward scrolling, is detected. If such scrolling is not detected, then the detection step S74 continues.

If scrolling in the first direction is detected, then in a step S76 a determination is made as to whether a predetermined percentage of the web page has been displayed in the display region. This is not a determination of the percentage of the web page which is currently displayed, but requires a determination of the percentage of the web page which is currently displayed, and those portions of the web page which have previously been displayed.

The determined percentage is compared with a threshold percentage. If the threshold is not met, then the process remains in step S76.

If the threshold condition is met, then in a step S78 it is determined whether the scrolling in the first direction has stopped. If it has not, then the process remains in step S78.

If it is determined in step S78 that scrolling in the first direction has ended, then in a step S80 the process then monitors for detection of scrolling in a second direction.

If no such scrolling is detected, then the process remains in step S80.

If scrolling in the second direction is detected, then exit intent is inferred in step S82.

In further examples, a further threshold condition may have to be met prior to step S80 being enabled, such threshold being any one of the conditions described above or below in relation to other examples.

In an example, the exit intent in step S82 may be inferred as soon as the scrolling in the second direction is detected. In further examples, a different or additional threshold condition may have to be met prior to step S82 being enabled to infer exit intent, such threshold condition being any one of the conditions described above or below in relation to other examples.

In a preferred example the exit intent is set following detection of scrolling in the first direction together with determination that a certain percentage of the web page has been displayed, followed by scrolling in the second direction.

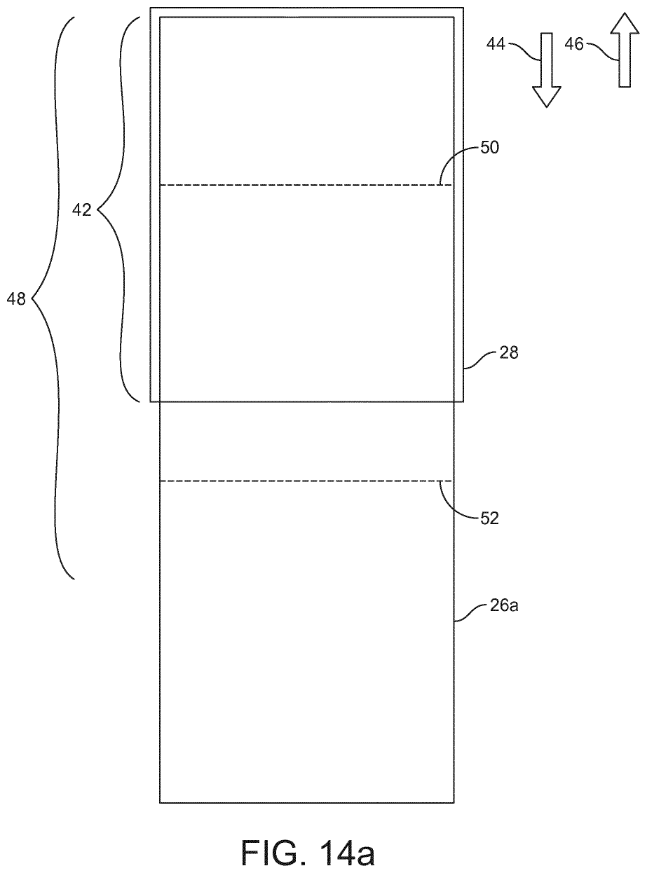

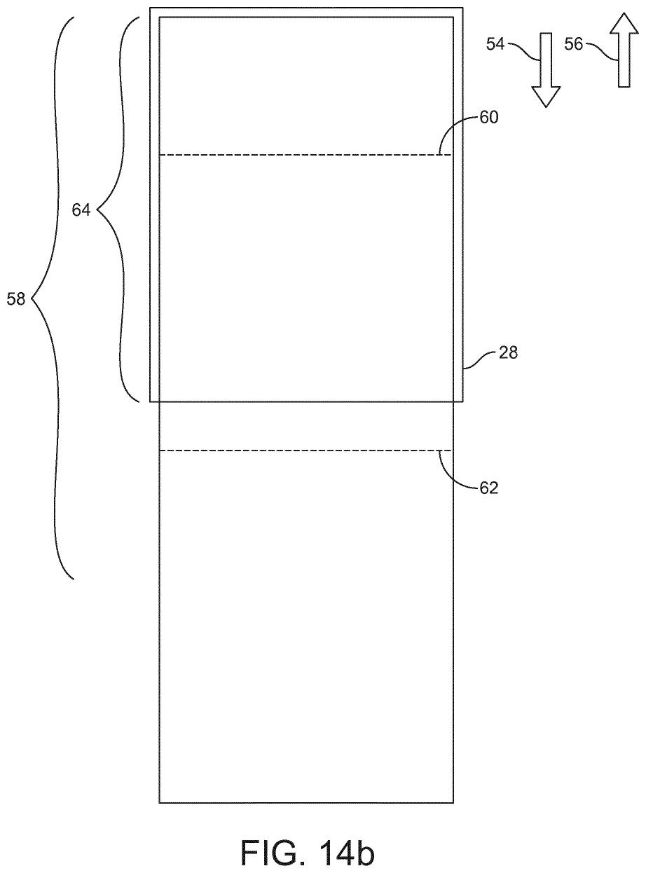

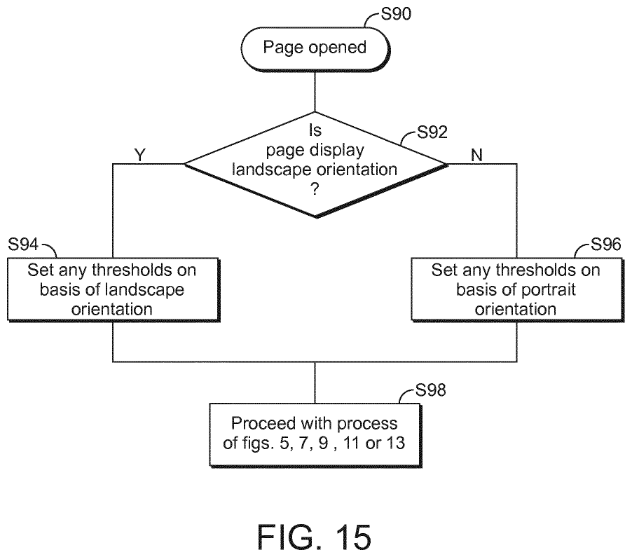

A sixth example technique is described with reference to FIGS. 14(a) and 14(b). In this sixth example technique, website exit intent may be inferred by detecting scroll up and/or scroll down of the web page in combination with detection of a threshold condition, and the threshold associated with the threshold condition may vary.

With reference to FIG. 14(a), there is again illustrated the web page 26 and the display portion 28 of the exemplary mobile device. Again is shown in FIG. 14(a) that when the web page 26 is initially opened only a top portion, as denoted in FIG. 14(a) by reference numeral 42, of the web page is visible in the display portion 28. The user must scroll down the web page 26 to show further portions of the web page 26 in the display region 28. On opening the web page the scenario as shown in FIG. 14(a) is presented, with an upper most portion of a web page 26 (denoted by reference numeral 42) displayed in the display region 28.

In accordance with various ones of the examples described above, one or more thresholds may be set in the arrangements of FIG. 14(a).

A threshold may be set associated with the speed of downward scrolling, as denoted by arrow 44. A threshold may be set as denoted by the speed of upward scrolling, as denoted by arrow 46. A threshold may be set as denoted by reference numeral 52, marking a location on the web page outside the initial viewing region. A threshold may be set as denoted by reference numeral 50 marking a location on the web page inside the initial viewing region. A threshold may be set as denoted by reference numeral 48, denoting a percentage of the web page. A threshold may be set corresponding to a distance of scrolling in the second direction, e.g. the threshold denoted by reference numeral 34 or 46 in the examples relating to FIGS. 8(d) and 10(d).

The use of all these thresholds will be apparent from the foregoing description, and the detection of one or all of the thresholds may be used in any implementation, in addition to detection of downward or upward scrolling.

The thresholds are preferably set in dependence on the orientation of the display region 28, and thus the orientation of the device associated with the display region. In the example, a so-called portrait orientation is assumed.

However, the user may re-orientate the device in order to display a web page in the display region orientated in a so-called landscape orientation. This is illustrated in FIG. 14(b). In view of the change in orientation, the length of the web page may change, and in this example shortens, in view of more content being fitted on the width of the page.

In accordance with a sixth example, therefore, when the orientation of the display region changes, one or more defined thresholds may be changed.

In the arrangement of FIG. 14(b), each threshold is changed due to the re-orientation. The content of the web page visible initially in the display region is denoted by reference numeral 64.

A new threshold may be set associated with the speed of downward scrolling, as denoted by arrow 54. A new threshold may be set as denoted by the speed of upward scrolling, as denoted by arrow 56. A new threshold may be set as denoted by reference numeral 56, marking a location on the web page outside the initial viewing region. A new threshold may be set as denoted by reference numeral 60 marking a location on the web page inside the initial viewing region. A new threshold may be set as denoted by reference numeral 58, denoting a percentage of the web page.

New thresholds may also be set denoting the distance of scrolling in the second direction, in accordance with the distances denoted by reference numerals 34 or 46 in the examples of FIGS. 8(d) and 10(d).

The use of all these thresholds will be consistent with their use in the foregoing description, and the change provided is in the value of the threshold, not in its purpose.

An exemplary process associated with this sixth example is shown in FIG. 15.

In a step S90 a web page is opened and is displayed in accordance with FIG. 14(a).

In a step 92, a determination is made as to whether the page is displayed in landscape orientation. In this example, the page can only be displayed in landscape or portrait orientation. However other possibilities may exist in different scenarios. The determination may be made utilising appropriate processes in the device which make the determination as to whether to present a web page in landscape or portrait form.

If it is determined is step S92 that the web page is in landscape form, then the process moves on to step S94 and any thresholds are set based on landscape presentation of the web page.

If however it is determined is step S92 that the web page is in landscape form, then the process moves on to step S96 and any thresholds are set based on landscape presentation of the web page.

After either step S94 or step S96, the process moves on to step S98 and a process in accordance with any previously described example is followed.

The setting of the thresholds may also vary in dependence on the type of user device, and the size of the display regions. A plurality of different thresholds may be provided, and selected from in dependence on any one of: the type of device; the size of the display region; and the orientation of the device.

Any threshold may be set by a web site associated with a web page, by an additional application associated with a web page, by the device itself, or according to the identity of a user of the device.

The threshold may be set dependent on the size of the web page relative to the size of the display region. The threshold may be set by a processor of a user device.

The setting of a threshold, and the choice of thresholds to use, will be implementation specific.

In accordance with this sixth example, whenever a threshold is set, multiple choices for that threshold are set each corresponding to the orientation of the web page in the display region.

All details of the examples described herein may be combined, in any combination of some or all aspects.

Examples may involve a sophisticated check of thresholds in combination. For example, scrolling up with a slow speed may not be taken to infer exit intent, even if a threshold number of pixels are exceeded. The fact that the user is scrolling up with a slow speed may imply that the user has scrolled upwards to read something on the web page, regardless of how far they have scrolled up. On the other hand, if a user scrolls upward quickly, even though only through a short distance (i.e. a small number of pixels) this may be taken as exit-intent because of the speed of the scrolling.

The trigger of exit intent may therefore be based on any desired sophistication.

The trigger processing may implement an algorithm.

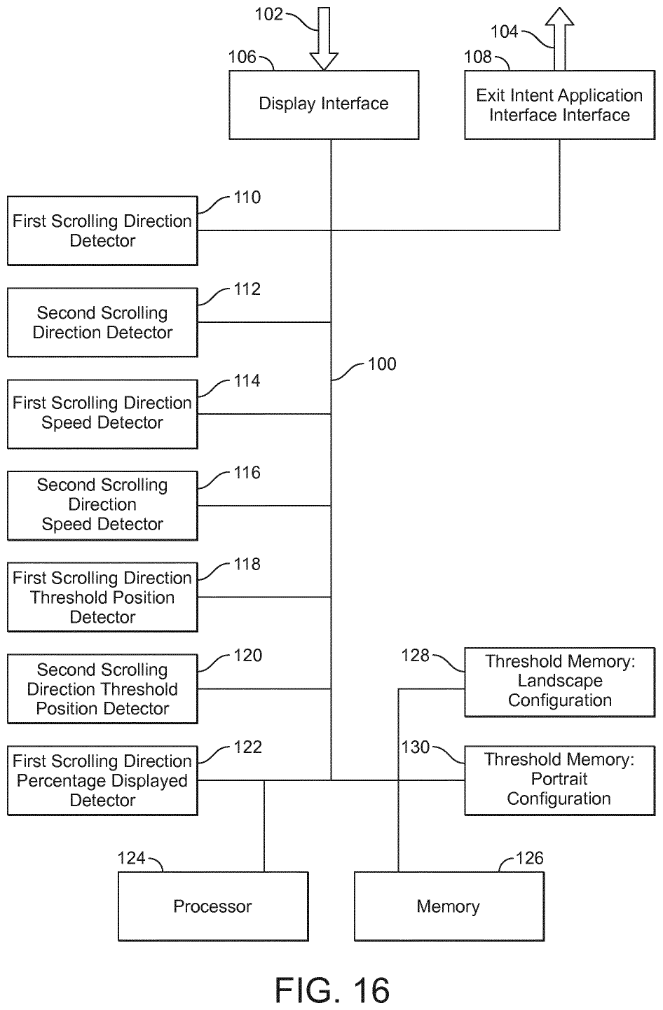

With reference to FIG. 16, there is illustrated an exemplary system architecture in a device for implementing any one of the examples as described.

The exemplary system architecture includes a display interface 106 connected to receive inputs from the display as denoted by signal lines 102. These inputs include scrolling inputs. The display interface is connected to a communication line 100 connected to all the elements of the exemplary system architecture.

A first scrolling direction detector 110 and a second scrolling direction detector 112 are connected to the communication line 100, for detecting scrolling in the respective directions in accordance with the above described examples, for example the process of FIG. 5 and other described example processes.

A first scrolling direction speed detector 114 and a second scrolling direction speed detector 116 are connected to the communication line 100, for detecting speed of scrolling in respective directions in accordance with the above described examples, for example the process of FIG. 7 and other described example processes.

A first scrolling direction threshold position detector 118 is connected to the communication line 100, and may be used for detecting the threshold line 30 of FIG. 8(a) or the threshold line 40 of FIG. 10(a) in accordance with the example processes of FIG. 9 or 11.

A second scrolling direction threshold position detector 120 is connected to the communication line 100, and may be used for detecting the threshold distance 34 of FIG. 8(d) or the threshold distance 46 of FIG. 10(d) in accordance with the example processes of FIG. 9 or 11.

A first scrolling direction percentage displayed detector 122 is connected to the communication line 100, and may be used for detecting the threshold in accordance with the example process described with reference to FIG. 13.

A threshold memory 128 (which may be part of a device memory 126 connected to the communication line 100) is connected to the communication line 100 and stores the threshold values associated with a landscape configuration.

A threshold memory 130 (which may be part of the device memory 126) is connected to the communication line 100 and stores the threshold values associated with a portrait configuration.

A processor 124 is connected to the communication line 100 and controls the various elements of the architecture as shown in FIG. 16 to perform the processes as described herein. For example the processor 124 operates to deliver the appropriate threshold values from the memory element 128 or 130 to the elements 110 to 122 for processing. The processor may also operate to set the thresholds in the memory 126, 128, 130 in dependence on knowledge of the display portion and knowledge of the web page.

In the foregoing, the purpose of the various examples is to determine when an exit intent is inferred. When an exit intent is inferred a 3^{rd} party functionality (or equivalent functionality provided by a website provider) may be invoked.

A 3^{rd} party software application may be provided to enhance the services provided by a website to a user. Such 3^{rd} party software applications may not be visible to a user as being provided by a 3^{rd} party. In some implementation the software application may not be provided by a 3^{rd} party, but may be an enhanced feature provided by a web site.

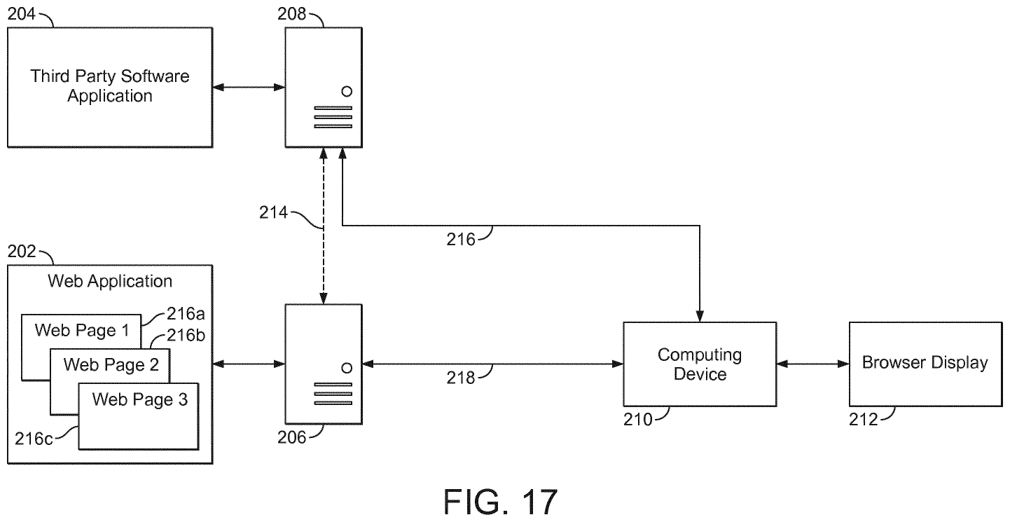

FIG. 17 illustrates an exemplary arrangement in which a 3^{rd} party software application is provided to a website, to offer additional functionality to a user when browsing the website. A website is associated with a web application 202 hosted by a server 206, and includes a plurality of web pages denoted by reference numerals 216a to 216c. A 3^{rd} party software application 204 is hosted by a server 208. In the described example a 3^{rd} party provides a 3^{rd} party software application, but the functionality of the described 3^{rd} party software application may be provided by the web application 202 itself. The functionality is described as being provided by a 3^{rd} party software application for ease of illustration and description.

A bi-directional dashed line 214 indicates a communication between the servers 206 and 208, which communication establishes a relationship between the web application and the 3^{rd} party application at some time prior to delivery of a web page. The 3^{rd} party application can provide additional 3^{rd} party services to the offerings of the web application based on an agreement between the 3^{rd} party application and the web application. The communication between the servers 206 and 208 may be provided by a network such as the Internet. Establishing of such a relationship is known.

A computing device 210 associated with a user is in communication with the server 206 to access the website associated with the web application 202. A bi-directional line 218 indicates communication between the server 206 and the computing device 210, which may be provided by a network such as the Internet. The computing device 210 is associated with a browser, with a browser display 212 displaying the browser to the user (or client), for example using a display of the computing device 210.

The browser associated with the computing device 210 makes a request for a web page from the server 206 by sending a request on communication line 218. In response thereto, the server 206 returns an associated web page to the computing device 210 for display by the browser in browser display 212.

The web page delivered by the server 206 to the computing device 210 includes control scripts. In this example it is assumed that the web application 202 is associated with a 3^{rd} party software application 204. These scripts will therefore include instructions relating to the 3^{rd} party software application as it is to be used in conjunction with the delivered web page.

In the present example, it is assumed that the web page is associated with the 3^{rd} party application 204, and the delivered web page includes in its scripts an instruction to the computing device 210 to fetch additional information from the 3^{rd} party software application 204. Thus on receipt of the web page, the computing device 210 additionally communicates with the server 208 on a bi-directional communication line 216 to retrieve the 3^{rd} party application (or applications) associated with the web page. The communication between the server 208 and the computing device 210 may be provided by a network such as the Internet. Such a communication is known.

An example of a service which the 3^{rd} party software application may provide is to infer a user exit (to initiate closure) of a page of a website associated with the web application in accordance with the described examples. When an exit intent is inferred, and before the actual exit takes place, there may be launched an instance of a service associated with the 3^{rd} party software application. This may be, for example, to generate a message for display to the use to prompt them to confirm that they wish to leave the web page, and may for example comprise offering a voucher to the user if they choose to stay on the web page rather than exit. This is an example of a service which may be offered by the 3^{rd} party software application, but the service offered is non-limiting.

The user may generally navigate the website associated with web application 202, and the functionality associated with the 3^{rd} party software application may be implemented.

Whilst herein it is described that the functionality is provided by a 3^{rd} party software application, it may be provided by a software application associated with the website, or the server hosting the website, and not specifically by a 3^{rd} party. In general it can be considered that additional functionality is provided to enhance the user experience, and that additional functionality may be further enhances utilising the examples for inferring exit intent as set out herein.

The description sets out scrolling up and scrolling down. In implementations scrolling may be scrolling left or scrolling right. In general scrolling is in any direction.

The description sets out a number of examples, and it will be apparent that each of these examples may be implemented separately or in any combinations. Any described example may be implemented in combination with all or part of any other example, or all or part of a plurality of other examples.

The description sets out examples particularly as might arise in a mobile telephone device or tablet device, where a user scrolls a web page using finger contact on a display of the device. However in general the principles described herein in all examples are applicable to scrolling generally, and are not limited to such a scenario. The examples apply to any scrolling scenario. Other scrolling scenarios may utilise a mouse, but the page is still scrolled.

The description sets out examples of manipulating a web page, and inferring exit intent from a web page. However in general the principles described herein in all examples are applicable to pages generally, and are not limited to web pages. Another example of a page is a page of an application. In general the described techniques apply to any page which is scrolled within a display region, regardless of the origin or association of that page.

The description sets out examples referring to scroll up and scroll down. However in general the principles described herein in all examples are applicable to scrolling in a first direction and scrolling in a second direction, scrolling up and scrolling down being terminology well used in the art to refer to scrolling on mobile phone devices or tablet devices. The scrolling in the first and second directions may be scrolling in opposite directions. The first and second directions may be vertical directions relative to the orientation of the device and presentation of content on a displayed page.

The feature that a user may need to ‘scroll up’ to access a menu icon to exit the displayed page is exploited by described examples to infer exit intent from scrolling, in combination with various optional thresholds/triggers.

An application implementing any described example may be enabled whenever a browser is enabled on a user device, or may be permanently enabled. The application may mimic the detection of pixels which causes a browser to be displayed.

A system or device may be provided with elements to implement the functionality described herein.

Any method or process described herein may be implemented in software. Such software may be provided on a user device, and/or downloaded to a user device. Such software may be provided on a computer program product, such as a non-transitory storage medium.

The invention has generally been described by way of example with reference to particular embodiments. The invention is not limited to the specifics of any embodiment, and details of any described embodiment may be combined.

What is claimed is:

1. A method of inferring exit behaviour of a user of a user device, the method comprising:
displaying a page in a display portion of the user device;
detecting scrolling of the displayed page;
detecting a threshold condition;
inferring an intent to exit the page in dependence on detecting scrolling in combination with the threshold condition being met, the method further comprising:
detecting the orientation of the display of the page within the display portion;
setting a threshold of the threshold condition in dependence on the orientation;
detecting if the orientation changes; and
changing the threshold if the orientation changes.

2. The method of claim 1 wherein the step of detecting scrolling of the displayed page comprises detecting scrolling of the displayed page in a first direction and detecting scrolling of the displayed page in a second direction.

3. The method of claim 2 wherein the step of inferring an intent to exit is in dependence on detecting scrolling in the first direction followed by scrolling in the second direction.

4. The method of claim 1 wherein the orientation indicates the orientation of the page with respect to the display portion, wherein the display portion is longer in one direction than the other, and in a first orientation the page is scrolled with respect to the shorter dimension, and in a second orientation the page is scrolled with respect to the longer dimension.

5. The method of claim 4 wherein in the first orientation the page is displayed in a landscape style and in the second orientation the page is displayed in a portrait style.

6. The method of claim 2 wherein the threshold is a predetermined position on the page which is not visible before the first scrolling, wherein the position is adjusted between orientations so as to be not visible in either orientation before first scrolling.

7. The method of claim 2 wherein the threshold is a predetermined position on the page which is visible before the first scrolling, wherein the position is adjusted between orientations so as to be visible in both orientations before first scrolling.

8. The method of claim 1 wherein the threshold comprises a scrolling speed threshold in any one of: a first direction; and a second direction.

9. The method of claim 1 wherein the threshold is a percentage of the page having been displayed in the display portion following a scrolling operation.

10. The method of claim 1 wherein the first and second directions are parallel to an edge of the display portion.

11. The method of claim 1 wherein the first direction is vertically downwards and the second direction is vertically upwards with respect to the edge of the display portion and an orientation of the displayed content.

12. The method of claim 1 wherein the page is a web page or a page of an application.

13. A computer program product for storing computer program code which, when executed on a computer, performs the method of claim 1.

14. A device comprising a display portion in which a page is displayed to a user, the page being larger than the display portion such that the page is scrolled in the display portion for display of the page to the user, the device further comprising:
a scrolling detector for detecting scrolling of the displayed page within the display portion;
a threshold detector for detecting a threshold condition;
a processor configured to infer an exit intent of the user from the displayed page in dependence on the detecting scrolling in combination with a threshold condition being met; and
an orientation detector for detecting the orientation of the display of the page within the display portion;
wherein the processor is further configured to:
set a threshold of the threshold condition in dependence on the orientation; and
adjust the threshold if the orientation changes.

15. The device of claim 14 wherein the scrolling detector comprises:
a first detector for detecting scrolling of the displayed page within the display portion in a first direction; and
a second detector for detecting scrolling of the displayed page within the display portion in a second direction different to the first direction, wherein the processor is configured to infer an exit intent in dependence on the first detector detecting scrolling in the first direction followed by the second detector detecting scrolling in the second direction.

16. The device of claim 14 further comprising a first speed scrolling detector for detecting a speed of scrolling in a first direction, the processor being configured to set a first speed scrolling threshold.

17. The device of claim 14 further comprising a second speed scrolling detector for detecting a speed of scrolling in a second direction, the processor being configured to set a second speed scrolling threshold.

18. The device of claim 14 further comprising a page location detector, configured to detect a position of a page appearing in the display region, the processor being configured to set a position threshold.

19. The device of claim 14 further comprising a page location detector, configured to detect a position of a page no longer appearing in the display region, the processor being configured to set a position threshold.

20. The device of claim 14 further comprising a displayed page detector for detecting the percentage of the page displayed in the displayed region following scrolling in one direction, the processor being configured to set a percentage threshold.
